(19) United States
(12) Patent Application Publication
(10) Pub. No.: US 2025/0033601 A1
(43) Pub. Date: Jan. 30, 2025

(54) Vehicular Side Windows Cleaning System and Method of Use

(71) Applicants: Stuart Meyerson, Staten island, NY (US); Joshua Meyerson, Staten Island, NY (US)

(72) Inventors: Stuart Meyerson, Staten island, NY (US); Joshua Meyerson, Staten Island, NY (US)

(21) Appl. No.: 18/782,675

(22) Filed: Jul. 24, 2024

Related U.S. Application Data
(60) Provisional application No. 63/516,102, filed on Jul. 27, 2023.

(51) Int. Cl. B60S 1/52; B60S 1/04; B60S 1/38; B60S 1/44; B60S 1/50

(52) U.S. Cl. CPC B60S 1/522; B60S 1/0466; B60S 1/38; B60S 1/44; B60S 1/50; B60S 2001/3829

(57) ABSTRACT

A vehicular side window cleaning system designed to clean the side windows of a vehicle is disclosed. The system includes a series of tubes running from the windshield wiper fluid tank or reservoir to the front doors (i.e., driver's side door and passenger's side door), the tubes are connected to a jet spray module with adjustable nozzles embedded inside each door. Upon activation by a control button near the driver's seat, the side windows lower, and water or washer fluid is dispensed from the jets. A high-durability rubber squeegee is mounted on the jet spray module and presses against the window as the window raises, removing water and debris. Excess water is collected in a basin at the bottom of the door and disposed of through an aperture or hose. The system also features a temperature control button for dispensing heated water to enhance cleaning efficiency in cold weather conditions.

### CROSS-REFERENCE TO RELATED APPLICATION

The present application claims priority to, and the benefit of, U.S. Provisional Application No. 63/516,102 which was filed on Jul. 27, 2023, and is incorporated herein by reference in its entirety.

### FIELD OF THE INVENTION

The present invention generally relates to the field of vehicle maintenance accessories. More specifically, the present invention relates to a novel side window cleaning system designed to automate and simplify the cleaning process for vehicle side windows. The system includes a series of tubes running from the windshield wiper fluid tank or reservoir to jet spray modules embedded inside at least the front doors (i.e., driver's side door and passenger's side door), adjustable jets for dispensing water, and a high-durability rubber squeegee for wiping the windows. The system is activated by a control button near the driver's seat, enhancing driver convenience and safety. Accordingly, the present disclosure makes specific reference thereto. Nonetheless, it is to be appreciated that aspects of the present invention are also equally applicable to other like applications, devices, and methods of manufacture.

### BACKGROUND

By way of background, driver and passenger side windows on a vehicle can accumulate dirt, salt residue, and debris quickly. While vehicles are equipped with windshield wipers to maintain clear visibility through the front and rear windows, they lack an efficient and convenient system for cleaning the side windows. Dirty side windows can block the view of side mirrors. Currently, drivers are required to stop at a convenience store or spend time at home using a squeegee and cleaning fluid to manually wipe away dirt and debris from the side windows. The manual process of cleaning side windows is time-consuming and inconvenient, especially for those who frequently travel in areas with high levels of road grime or during adverse weather conditions.

Often, drivers have to stop cars during their trips which obstructs the driving experience but also can cause delays and safety concerns. By maintaining optimal visibility through the side windows, an automated system can enhance safety by ensuring that drivers have a clear view of their surroundings, which is crucial for lane changes, merging, and parking. Accordingly, individuals desire an improved system for cleaning vehicular side windows.

Therefore, there exists a long-felt need in the art for an improved vehicular side window cleaning system. There is also a long-felt need in the art for a system that provides a convenient and automated method for cleaning vehicle side windows that reduces the manual effort required by drivers. Additionally, there is a long-felt need in the art for a side window cleaning system that enhances driver safety by maintaining clear visibility through the side windows. Moreover, there is a long-felt need in the art for a system that can be integrated into new vehicles or added as an aftermarket accessory. Further, there is a long-felt need in the art for a system that efficiently removes dirt, salt residue, and debris from side windows. Furthermore, there is a long-felt need in the art for a side window cleaning system that includes features such as heated jets and adjustable nozzles to improve cleaning performance in diverse environments. Finally, there is a long-felt need in the art for a comprehensive solution that simplifies the window cleaning process, saving time and effort for drivers while ensuring optimal visibility and safety.

The subject matter disclosed and claimed herein, in one embodiment thereof, comprises a vehicular side window cleaning system. The system features a plurality of tubes configured to run from a vehicle's windshield wiper fluid tank or reservoir to at least front doors (i.e., driver's side door and passenger's side door) of the vehicle, a jet spray module is embedded inside each front door, the jet spray module includes a plurality of jet nozzles for spraying water onto the corresponding window, a squeegee is pivotally disposed on the jet spray module, the squeegee is configured to press against the side window of the vehicle to remove water when the window is raised, a basin is disposed at the bottom of the front door for collecting excess water from the window, and a control button is located near a driver's seat, the control button is configured to activate the system, lower the side window to a predetermined position, and dispense water from the jets for a predetermined time period.

In this manner, the vehicular side window cleaning system of the present invention accomplishes all of the foregoing objectives and provides users with a novel solution for maintaining clean and clear side windows. The system includes a series of tubes running from the windshield wiper fluid tank or reservoir to a jet spray module embedded inside each door. The jets dispense water onto the windows, which is then wiped away by a high-durability rubber squeegee during the window's upward motion. The system features a control button near the driver's seat that activates the cleaning process, lowering the windows and spraying water for a predetermined time. The system simplifies the window cleaning process, saving time and effort for drivers, while ensuring optimal visibility and safety on the road.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicular side window cleaning system. The system comprises a plurality of tubes configured to run from a vehicle's windshield wiper fluid tank or reservoir to the front doors (i.e., driver's side door and passenger's side door) of the vehicle, a jet spray module embedded inside each front door, the jet spray module includes a plurality of jets, a squeegee pivotally disposed on the jet spray module, the squeegee configured to press against the side window of the vehicle to remove water when the window is raised, a basin disposed at the bottom of the front door for collecting excess water from the window, and a control button is located near a driver's seat, the control button is configured to activate the system, lower the side window to a predetermined position, and dispense water from the jets for a predetermined time period.

In yet another embodiment, a vehicular side window cleaning system is disclosed. The cleaning system comprises a series of tubes connected to a windshield wiper fluid tank or reservoir, the tubes running to the front doors (i.e., driver's side door and passenger's side door) of a vehicle and positioned internally along the vehicle's engine space, the tubes being flexible and insulating to prevent water heating, a jet spray module removably embedded inside each front door, the jet spray module having adjustable jet nozzles for providing a consistent and uniform mist of water on the window, a squeegee made of ethylene propylene diene monomer (EPDM) or silicone rubber is mounted on the jet spray module and is designed to apply consistent pressure against the window surface during upward motion, a control button is integrated with the vehicle's dashboard and connected to the vehicle's electronic control unit (ECU), the button is configured to lower the windows, activate the jets for a set duration, and engage the squeegee during the window's upward movement, and a drainage system comprising a basin at the bottom of each front door and a hose for directing excess water away from the vehicle.

The system includes a temperature button, the temperature button is configured to dispense heated water from the jets to improve cleaning efficiency in cold weather conditions.

In another embodiment, a method for cleaning side windows of a vehicle is disclosed. The method includes the steps of activating a control button located near a driver's seat to initiate a cleaning process, lowering a side window of the vehicle to a predetermined position, dispensing water from a plurality of jets embedded inside a front door of the vehicle, the water is carried by a series of tubes from a windshield wiper fluid tank or reservoir, raising the side window, while a squeegee made from high-durability rubber presses against the window to remove water and debris, and collecting excess water in a basin located at the bottom of the front door and disposing of the water through a connected hose.

In still another embodiment, the jet nozzles are automatically adjustable to ensure thorough cleaning of the window.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the vehicular side window cleaning system of the present invention in accordance with the disclosed structure;

FIG. 2 illustrates a perspective view of the dashboard of the vehicle showing a control button for controlling operation of the vehicular side window cleaning system of the present invention in accordance with the disclosed structure;

FIG. 3 illustrates an enlarged view of the jet spray module used in the vehicular side window cleaning system of the present invention in accordance with the disclosed structure;

FIG. 4 illustrates a flow chart depicting a process of operation of the side window cleaning system of the present invention in accordance with the disclosed structure; and

FIG. 5 illustrates a perspective view of the dashboard of the vehicle showing another control system for controlling the window cleaning system in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicular side window cleaning system. There is also a long-felt need in the art for a system that provides a convenient and automated method for cleaning vehicle side windows that reduces the manual effort required by drivers. Additionally, there is a long-felt need in the art for a side window cleaning system that enhances driver safety by maintaining clear visibility through the side windows. Moreover, there is a long-felt need in the art for a system that can be integrated into new vehicles or added as an aftermarket accessory. Further, there is a long-felt need in the art for a system that efficiently removes dirt, salt residue, and debris from side windows. Furthermore, there is a long-felt need in the art for a side window cleaning system that includes features such as heated jets and adjustable nozzles to improve cleaning performance in diverse environments. Finally, there is a long-felt need in the art for a comprehensive solution that simplifies the window cleaning process, saving time and effort for drivers while ensuring optimal visibility and safety.

The present invention, in one exemplary embodiment, is a method for cleaning side windows of a vehicle. The method includes the steps of activating a control button located near a driver's seat to initiate a cleaning process, lowering a side window of the vehicle to a predetermined position, dispensing water from a plurality of jets embedded inside a front door of the vehicle, the water is carried by a series of tubes from a windshield wiper fluid tank or reservoir, raising the side window, while a squeegee made from high-durability rubber presses against the window to remove water and debris, and collecting excess water in a basin located at the bottom of the front door and disposing of the water through a connected hose.

Reference will now be made in detail to the present preferred embodiments of the invention, examples of which are illustrated in the accompanying drawings. Wherever possible, the same reference numerals are used in the drawings and the description to refer to the same or like parts.

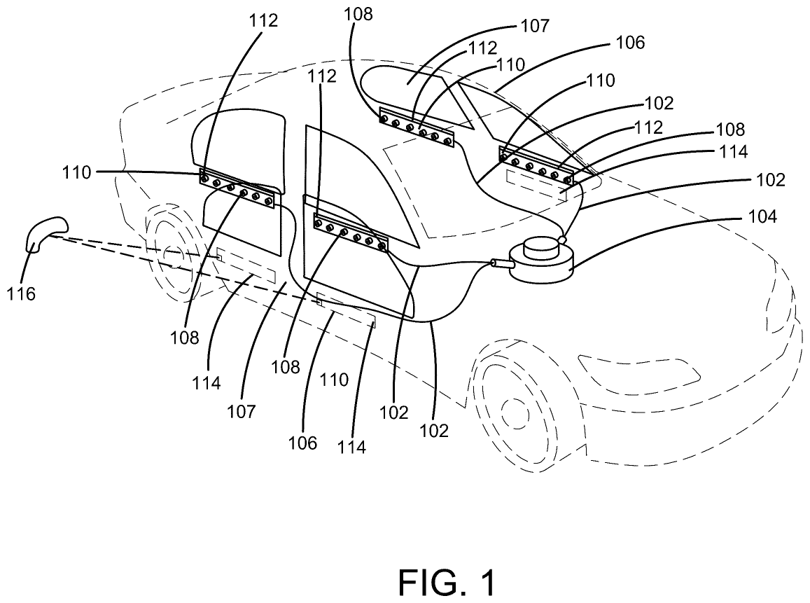

Referring initially to the drawings, FIG. 1 illustrates a perspective view of the vehicular side window cleaning system of the present invention in accordance with the disclosed structure. The side window cleaning system 100 of the present invention is designed to clean the side windows of a vehicle and can be implemented as an integrated system in new vehicles or as an aftermarket add-on for existing vehicles. More specifically, the system 100 includes a plurality of tubes 102 adapted to run from the vehicle's windshield wiper fluid tank or reservoir 104 to the doors of the vehicle, for example front doors (i.e., driver's side door and passenger's side door) 106 and rear doors 107. The tubes 102 are positioned internally in the vehicles such as along the engine space of the vehicle and can be flexible for enabling proper positioning inside the vehicle. The tubes 102 are insulating and prevent the water or windshield washer fluid transmitted therethrough from freezing. Preferably, the tubes 102 are high-pressure rubber or plastic tubing made of polyurethane or PVC and have an inner diameter from about 4 mm to about 6 mm for adequate fluid flow. The tubes 102 can support water pressure of up to 100 psi.

A plurality of jets 108 are disposed in a jet spray module 110 wherein the jet spray module 110 is embedded inside the front door 106 of the vehicle. The tube 102 carries the water or washer fluid from the tank or reservoir 104 to the plurality of jets 108 and the water or washer fluid is dispensed from the plurality of jets 108 as illustrated later in the disclosure. The water or washer fluid from the jets 108 is dispensed on the exterior of the window when the window is lowered to a predetermined position such as in front of and/or below the jets 108 for cleaning the window.

A squeegee 112 such as a rubber squeegee which is adapted to actuate as a windshield wiper in a pivotal motion or actuate in a linear motion horizontally against the exterior of the window disposed on the jet spray module 110. The squeegee 112 is adapted to press against the exterior of the window to remove water (and/or washer fluid) when the window is raised. A basin 114 is disposed at the bottom of each door 106 for collecting excess water that comes off the window. The water or washer fluid from the basin 114 is drained off using a hose 116 which can be any conventional hose. The squeegee 112 is made from high-durability rubber such as EPDM or silicone rubber. The squeegee 112 is designed to apply consistent pressure against the window surface during the upward motion.

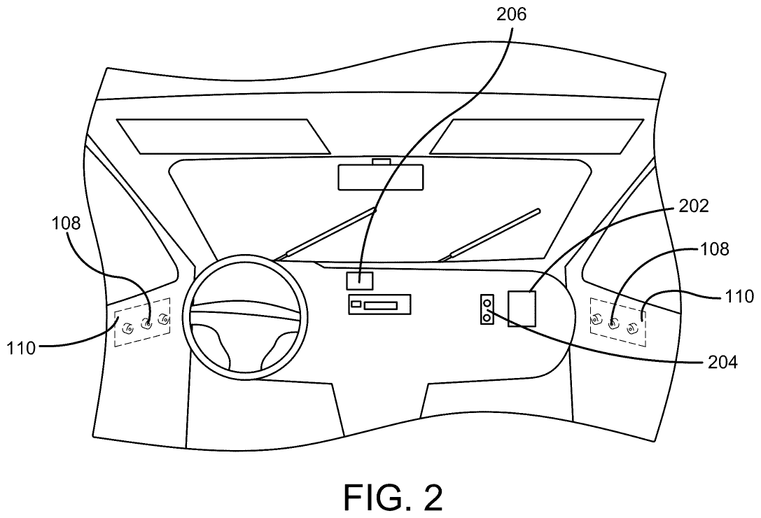

FIG. 2 illustrates a perspective view of dashboard of the vehicle showing a control button for controlling operation of the vehicular side window cleaning system of the present invention in accordance with the disclosed structure. As illustrated, the dashboard 202 includes a control button 204 which is positioned near the driver's seat to activate the system 100. Preferably, the control button 204 is coupled to the electronic control unit (ECU) 206 of the vehicle. When the control button 204 is pressed, the side windows lower to a predetermined position inside the corresponding front doors and water or washer fluid is dispensed from the jets 108.

Water or washer fluid is dispensed from the jets 108 for a predetermined time period such as 3 seconds, 5 seconds, and more and then, the squeegee 112 is activated automatically to pull (i.e., squeegee) water from the exterior of the window and store in the basin 114. The system 100 provides an easy way for drivers to clean their side windows without having to manually wipe them and ensures clear visibility through side windows, which is crucial for lane changes and parking.

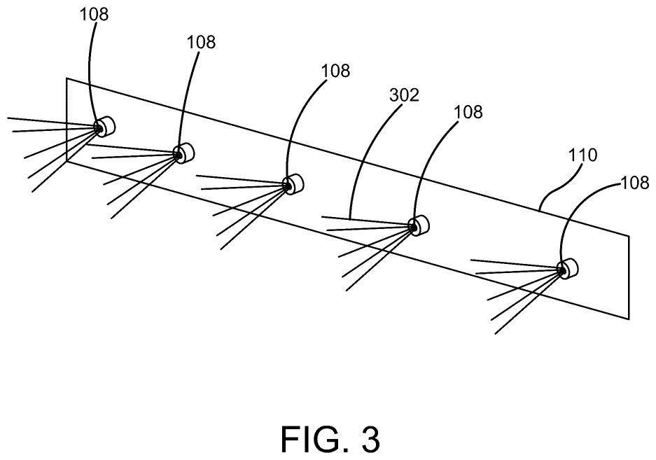

FIG. 3 illustrates an enlarged view of the jet spray module used in the vehicular side window cleaning system of the present invention in accordance with the disclosed structure. The jet spray module 110 is removably disposed inside the doors 106 and can include 4-6 jets 108 for providing a consistent and uniform mist of water 302 on the window. Each jet nozzle 108 can have a 0.5 to 1.0 mm aperture and is adapted for 30 to 60 psi. The jet nozzles 108 are adjustable and can be automatically adjusted for a thorough cleaning of the window. Each jet nozzle 108 can be made from high-grade stainless steel or durable plastic.

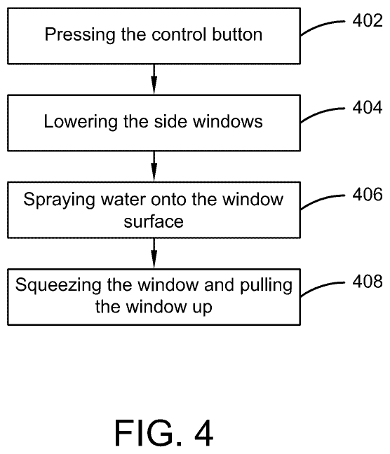

FIG. 4 illustrates a flow chart depicting a process of operation of the side window cleaning system of the present invention in accordance with the disclosed structure. Initially, a driver initiates the cleaning process of windows by pressing the control button (Step 402). The control button triggers the electronic control system to lower the side windows (Step 404). It should be noted that the control button can be a separate button from generic side window control button for conventional lowering and raising the windows. Thereafter, the jets 108, controlled by the system 100, spray the water onto the window surface (Step 406) wherein the water is carried by the tubes 102 from the tank or reservoir 104. The water helps to loosen and remove dirt and debris. Finally, the window is raised up and during the upward motion, the rubber squeegee 112 presses against the exterior of the window to wipe away the fluid along with any dirt (Step 408).

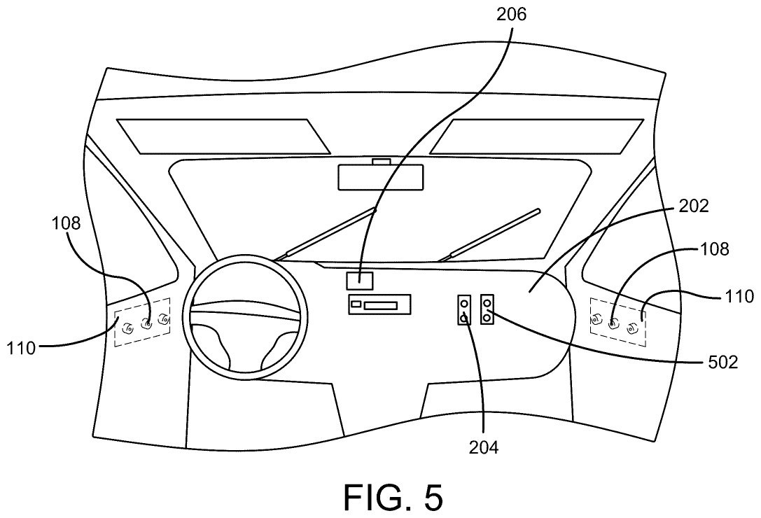

FIG. 5 illustrates a perspective view of the dashboard of the vehicle showing another control system for controlling the automated side window cleaning apparatus for vehicles in accordance with the disclosed structure. In the present invention, the system 100 includes the control button 204 for activating the system and a hot temperature button 502 is included which when pressed dispenses hot water from the jets 108. The temperature button 502 improves cleaning efficiency in cold weather conditions.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated side window cleaning apparatus for vehicles”, “vehicular side window cleaning system”, “side window cleaning system”, and “system” are interchangeable and refer to the vehicular side window automated cleaning system 100 of the present invention.

Notwithstanding the forgoing, the vehicular side window automated cleaning system 100 of the present invention can be of any suitable size and configuration as is known in the art without affecting the overall concept of the invention, provided that it accomplishes the above stated objectives. One of ordinary skill in the art will appreciate that the vehicular side window automated cleaning system 100 as shown in the FIGS. are for illustrative purposes only, and that many other sizes and shapes of the vehicular side window automated cleaning system 100 are well within the scope of the present disclosure. Although the dimensions of the vehicular side window automated cleaning system 100 are important design parameters for user convenience, the vehicular side window automated cleaning system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle side window cleaning system comprising:
a plurality of tubes;
a reservoir;
a jet spray module;
a plurality of jets; and
a squeegee;
wherein said plurality of tubes connecting said reservoir to doors of the vehicle;
wherein said reservoir having washer fluid;
wherein said doors of the vehicle are front doors of the vehicle;
wherein said plurality of tubes are flexible and positioned internally in said front doors of the vehicle;
wherein said plurality of jets spray said washer fluid onto an exterior of windows of said front doors of the vehicle; and
further wherein said squeegee actuated within said front doors of the vehicle in a motion selected from the group consisting of a pivotal motion and a horizontal motion.

2. The vehicle side window cleaning system of claim 1, wherein said plurality of tubes are insulated for prohibiting freezing of said washer fluid transmitted therethrough.

3. The vehicle side window cleaning system of claim 1, wherein said plurality of tubes having a material selected from the group consisting of a high-pressure rubber, plastic tubing, a polyurethane, and a PVC.

4. The vehicle side window cleaning system of claim 1, wherein said plurality of tubes having a diameter from 4 mm to 6 mm for adequate said washer fluid flow.

5. The vehicle side window cleaning system of claim 1, wherein said squeegee having a material selected from the group consisting of a rubber, an EPDM, and a silicone rubber.

6. The vehicle side window cleaning system of claim 1, wherein said doors of the vehicle include rear doors of the vehicle.

7. The vehicle side window cleaning system of claim 1, wherein said plurality of jets and said jet spray module embedded inside said front doors of the vehicle.

8. The vehicle side window cleaning system of claim 1, wherein said plurality of tubes in fluid communication between said reservoir and said plurality of jets.

9. The vehicle side window cleaning system of claim 8, wherein said plurality of jets spray said washer fluid onto an exterior of windows when the windows are lowered to a predetermined position in said front doors of the vehicle.

10. The vehicle side window cleaning system of claim 9, wherein said squeegee actuates while the windows are raised in said front doors of the vehicle.

11. A vehicle side window cleaning system comprising:
a plurality of tubes;
a reservoir;
a jet spray module;
a plurality of jets; and
a squeegee;
wherein said plurality of tubes connecting said reservoir to doors of the vehicle;
wherein said reservoir having washer fluid;
wherein said doors of the vehicle are front doors of the vehicle;
wherein said plurality of tubes are flexible and positioned internally in said front doors of the vehicle;
wherein said plurality of jets spray said washer fluid onto an exterior of windows of said front doors of the vehicle;
wherein said plurality of jets and said jet spray module embedded inside said front doors of the vehicle;
wherein said squeegee actuated within said front doors of the vehicle in a horizontal motion; and
further wherein said squeegee actuates while the windows are raised in said front doors of the vehicle.

12. The vehicle side window cleaning system of claim 11, wherein said plurality of tubes are insulated for prohibiting freezing of said washer fluid transmitted therethrough.

13. The vehicle side window cleaning system of claim 11, wherein said plurality of tubes having a material selected from the group consisting of a high-pressure rubber, plastic tubing, a polyurethane, and a PVC.

14. The vehicle side window cleaning system of claim 11, wherein said plurality of tubes having a diameter from 4 mm to 6 mm for adequate said washer fluid flow.

15. The vehicle side window cleaning system of claim 11, wherein said squeegee having a material selected from the group consisting of a rubber, an EPDM, and a silicone rubber.

16. The vehicle side window cleaning system of claim 11, wherein said doors of the vehicle include rear doors of the vehicle.

17. The vehicle side window cleaning system of claim 11, wherein said plurality of tubes in fluid communication between said reservoir and said plurality of jets.

18. The vehicle side window cleaning system of claim 17, wherein said plurality of jets spray said washer fluid onto an exterior of windows when the windows are lowered to a predetermined position in said front doors of the vehicle.

19. A method of cleaning vehicle side windows, the method comprising the steps of:
providing a plurality of tubes, a reservoir, a jet spray module, a plurality of jets, and a squeegee, wherein said plurality of tubes connecting said reservoir to doors of the vehicle, wherein said reservoir having washer fluid, further wherein said doors of the vehicle are front doors of the vehicle;
positioning said plurality of tubes internally in said front doors of the vehicle;
lowering windows of said front doors of the vehicle;
spraying said washer fluid from said plurality of jets onto an exterior of windows of said front doors of the vehicle, wherein said plurality of jets and said jet spray module embedded inside said front doors of the vehicle; and
actuating said squeegee within said front doors of the vehicle in a horizontal motion while the windows are raised in said front doors of the vehicle.

20. The method of cleaning vehicle side windows of claim 19, wherein said plurality of jets spray said washer fluid onto an exterior of windows when the windows are lowered to a predetermined position in said front doors of the vehicle.
